(19) United States
(12) Patent Application Publication
(10) Pub. No.: US 2026/0318282 A1
(43) Pub. Date: Oct. 15, 2026

(54) Computer-Implemented Method And Device For Adjusting A Blade Load Measurement System Of A Rotor Blade Of A Wind Turbine, Wind Turbine Having At Least One Rotor Blade With A Strain Sensor, And Computer-Readable Storage Medium

(71) Applicant: Polytech A/S, Bramming (DK)

(72) Inventors: Christoph KLEIN, Bramming (DK); Bastian PETEREK, Bramming (DK)

(73) Assignee: Polytech A/S, Bramming (DK)

(21) Appl. No.: 19/104,485

(22) PCT Filed: Aug. 17, 2023
(86) PCT No.: PCT/EP2023/072639

§ 371 Date: Feb. 18, 2025

(30) Foreign Application Priority Data
Aug. 18, 2022 (EP) 22190971.6

(51) Int. Cl. F03D 17/00

(52) U.S. Cl. CPC F03D 17/011; F03D 17/025; F03D 17/028; F05B 2270/807; F05B 2270/808

(57) ABSTRACT

A computer-implemented method for adjusting a blade load measurement system having a strain sensor on a rotor blade of a wind turbine, having the following steps: measuring an acceleration with an acceleration sensor; determining a reference bending moment and/or a reference axial force based on the measured acceleration; determining a measured bending moment and/or a measured axial force based on measured values from the strain sensor of the blade load measurement system and an adjustment parameter set with initial adjustment parameter values associated with the blade load measurement system; determining a deviation of the reference bending moment and/or the reference axial force from the measured bending moment and/or the measured axial force; adapting the adjustment parameter values of the adjustment parameter set for the blade load measurement system such that the deviation is less than or equal to a threshold value.

### TECHNICAL FIELD

The present invention generally relates to a computer-implemented method and a device for adjusting a blade load measurement system of a rotor blade of a wind turbine, a wind turbine having at least one rotor blade with a strain sensor, and a computer-readable storage medium.

### BACKGROUND

A wind turbine converts wind energy into electrical energy. The wind exerts a force on at least one rotor blade of a rotor of the wind turbine, so that kinetic energy of the wind is converted into kinetic rotational energy of the rotor. The rotor drives an electric generator which feeds electrical energy into an electricity grid.

More and more often, one or more rotor blades of a wind turbine are equipped with one or more sensors, e.g., strain sensors, which are used for control purposes, in particular for load reduction, and/or for monitoring system operation, in particular for safety and maintenance purposes. Forces and/or moments acting on the rotor blade are determined from the strains measured by the strain sensors. In order to obtain reliable and correct measured values from the strain sensors and hence correct load measurement results, the strain sensors must be adjusted prior to commissioning, i.e., a deviation of a measured load value from a target value (reference) is observed and documented. The adjustment parameters for the strain sensors are then set or tuned such that a measurement deviation from a target value is as small as possible or lies within a defined specification or tolerance limits.

To date, for adjusting a strain sensor for blade load measurement, a mass of the rotor blade, an arrangement of the sensors at this rotor blade, a current rotor angle of the turbine of the wind turbine, a current wind speed and a current pitch angle have been detected. Of these, the pitch angle and the current rotor angle constitute the most important input parameters. The current wind speed is used for a filter mechanism to filter out measurements recoded at wind speeds which are so high that the measurement results may be become distorted. High wind speeds cause additional moments, making an adjustment inaccurate so that filtering improves the adjustment quality of the strain sensor.

For the actual adjustment, a controlled and defined run is conducted with the rotor blade, for example, multiple revolutions at a low wind speed. In particular, the pitch angle of the rotor blade is selectively controlled and set differently. As wind turbines are operated with different pitch angles, it is necessary to perform adjustment runs at different pitch angles to fully map the behaviour of the strain sensors. The rotor blade is brought to defined positions at which known forces or bending moments act on the rotor blade. For example, defined positions are positions of the rotor blades perpendicular or parallel to the earth's surface. The position the rotor blade is in can be clearly determined by measuring the current rotor angle. This means that a measurement of the rotor angle is absolutely necessary for an adjustment. For example, in these defined positions, only a gravitational force acts on the rotor blade. At low wind speeds, the aerodynamic forces acting on the rotor blade are negligible. Bending moments and axial forces acting on the rotor blade are determined taking into account the acting gravity, the position of the strain sensors and the mass of the rotor blade. At the same time, the strain sensors detect forces or bending moments based on an initial adjustment parameter set. Since the acting forces or moments are known, the forces or bending moments measured by the strain sensors are compared to the known forces or bending moments and the adjustment parameter set for the strain sensors is adjusted according to the deviation.

As an example, EP 2 531 722 A1 teaches a method for in-situ adjustment of load sensors of a wind turbine. Therein, a rotor azimuth angle and an angle of attack of the first wind turbine blade are determined first. In a next step, loads in the first cross section of the first wind turbine blade are measured using the first load sensors. Based on the rotor azimuth angle and the angle of attack, theoretical loads acting on the blade are calculated. The measured loads are compared to the calculated theoretical loads, and the first load sensor is adjusted based on the comparison.

### Problems Solved by the Invention

A disadvantage of the previous method described for adjusting a strain sensor is that the current rotor angle of the turbine of the wind turbine must be detected. However, often, a rotor angle cannot be measured clearly because, due to measurement inadequacies, an angular offset occurs between the real and measured rotor angles. If interference signals occur or if the detected signal of the rotor angle is unreliable or inaccurate, this will affect the adjustment of the strain sensor.

Based on this prior art, it is an object of the present invention to overcome the disadvantages mentioned. There is a need for a way to adjust strain sensors accurately and reliably, especially without measuring or using a rotor angle.

### Means to Solve the Problem

The object is achieved by a computer-implemented method for adjusting a first blade load measurement system having at least one strain sensor on a first rotor blade of a wind turbine according to claim 1. This enables simple and accurate adjustment of the blade load measurement system, and a measurement or use of a rotor angle or a use of a rotor angle in the adjustment process is omitted. The object is further achieved by a device for adjusting a first blade load measurement system having at least one strain sensor on a first rotor blade of a wind turbine according to claim 9, by a wind turbine according to claim 13, and by a computer-readable storage medium according to claim 14.

In particular, the object is achieved by a computer-implemented method for adjusting a first blade load measurement system having at least one strain sensor on a first rotor blade of a wind turbine, having the following steps:
a) measuring a first acceleration with a first acceleration sensor;
b) determining a first reference bending moment and/or a first reference axial force based on the first measured acceleration;
c) determining a first measured bending moment and/or a first measured axial force based on measured values from the at least one strain sensor of the first blade load measurement system and a first adjustment parameter set with first initial adjustment parameter values associated with the first blade load measurement system;
d) determining a first deviation of the first reference bending moment and/or the first reference axial force from the first measured bending moment and/or the first measured axial force;
e) adapting the adjustment parameter values of the first adjustment parameter set for the first blade load measurement system such that the first deviation is less than or equal to a threshold value.

Therefore, an idea of the present invention is to adjust a blade load measurement system without using a rotor angle of the wind turbine. An adjustment based on accelerations may be suitable for increasing the accuracy of the adjustment.

A blade load measurement system may in particular be understood to mean a strain sensor system which comprises at least one strain sensor, in particular multiple strain sensors, in particular at least three, more particularly at least four strain sensors. at least four strain sensors. The at least one strain sensor may be configured as a strain sensor measuring one or more strains in one direction. Preferably, the strain sensor may be positioned and oriented such that it measures one or more strains in the direction of a blade axis. For this purpose, the strain sensor may be arranged in any first plane of the rotor blade cross section. In particular, a plane of a rotor blade cross section may be understood to mean a plane through a cross section of a rotor blade, which is orthogonal to a blade axis of the rotor blade. In particular, the strain sensor may be configured to measure multiple strains in the direction of the blade axis, which are required for determining axial forces and/or bending moments. In particular, if the strain sensor can only measure strain in the direction of the blade axis, the blade load measurement system may comprise multiple strain sensors which may also detect strains in the direction of the blade axis. In principle, these strain sensors may be arranged in any planes which may be the same or different from one another. For example, the strain sensors may each be arranged in a common plane, for example in the first plane of the rotor blade cross section or in multiple planes of the rotor blade cross section spaced apart from one another.

The first acceleration sensor may detect a first acceleration acting in a rotating rotor hub. For example, the first acceleration sensor may be an acceleration sensor system measuring accelerations in three orthogonal spatial directions. For example, the first acceleration sensor may be provided by a 6-DOF acceleration sensor.

In particular, a first measured acceleration may be understood to mean an acceleration which comprises acceleration components in multiple spatial directions, in particular in three, in particular orthogonal, spatial directions.

According to the invention, the first reference bending moment and/or the first reference axial force is determined based on the first measured acceleration. In particular, the determination of the first reference bending moment and/or the first reference axial force is carried out without taking the rotor angle into account.

Whether the first measured bending moment and/or the first measured axial force are taken into account for the adjustment may depend on the number of strain sensors in particular. For example, when using three strain sensors, the first measured axial force may be taken into account. For example, if four strain sensors are used, the first measured bending moment or alternatively the first measured axial force and the first measured bending moment may be used.

According to the invention, the first measured bending moment and/or the first measured axial force are determined based on the measured values from the at least one strain sensor of the first blade load measurement system and the initial adjustment parameter values of the first adjustment parameter set associated with the first blade load measurement system.

The first reference bending moment and/or the first reference axial force may be compared to the first measured bending moment and the first measured axial force, and a first deviation between the first reference bending moment and/or the first reference axial force from the first measured bending moment and/or the first measured axial force may be determined.

Based on the first deviation, the adjustment parameter values of the first adjustment parameter set are determined such that the first deviation is less than or equal to a threshold value. If the first deviation is less than or equal to a defined threshold value, the adjustment parameter values of the first adjustment parameter set are selected for the adjustment. For example, the threshold value may indicate a first deviation of no more than 5.00%, preferably no more than 3.00%, more preferably no more than 1.00%.

The first adjustment parameter set of the first blade load measurement system may comprise one or more suitable parameters for adjusting the first blade load measurement system or the strain sensor. The initial adjustment parameter values of the first adjustment parameter set may be any specified parameter values. The calculation time may be shortened if suitable adjustment parameter values are specified as initial adjustment parameter values. For example, in particular initial, adjustment parameter values of an adjustment parameter set of a structurally and functionally similar wind turbine may be used. Optionally, in particular initial, adjustment parameter values may be used which are determined from a stiffness of the first rotor blade and/or a position of the first strain sensor and/or a wavelength of the first strain sensor.

Based on the adapted adjustment parameters of the adjustment matrix, the bending moments in the load reference plane may be determined in mutually orthogonal load vectors, and/or the axial forces acting orthogonally to the load reference plane may be determined.

The first axial force may indicate a force acting from the hub centre along the blade axis towards the blade tip. In addition, a force acting in the centre of gravity of the first rotor blade may be determined from the first measured acceleration and the mass of the first rotor blade. Furthermore, a first bending moment may be determined based on the weight and a distance of the centre of gravity of the rotor blade from the hub centre. The mass and the centre of gravity of the first rotor blade maybe determined, for example, from a data sheet of the first rotor blade or by weighing the rotor blade in a step of rotor blade production or prior to assembly of the first rotor blade. This has the advantage that a first bending moment and/or a first axial force relating to the blade flange may be readily deduced from the mass of the first rotor blade, the distance of the centre of gravity from the blade flange and the first measured acceleration alone. Furthermore, a design mass distribution may also be utilised to determine the centre of gravity and mass in relation to each blade radius position and thus to adjust bending moments and/or axial forces in relation to this blade section.

As already described, the wind turbine may comprise at least a first rotor blade. Further, the wind turbine may comprise multiple, in particular two, more particularly three, rotor blades. The rotor blades may each be arranged evenly around the hub at an angular offset from one another. For example, if two rotor blades are provided, they may be arranged at an angular offset of 180° to one another. For example, if three rotor blades are provided, they may be arranged at an angular offset of 120° each to each other. The rotor blades may be identical or at least nearly identical in terms of their dimensions, their mass, their mass distribution and their centre of gravity and thus their static moment, i.e., the product of the mass and the distance of the centre of gravity from a reference point. The deviation is preferably no more than 5%, preferably no more 2%, more preferably 1%.

In an advantageous embodiment, the method may comprise adjusting a second blade load measurement system having at least one strain sensor on a second rotor blade, having the following steps:
a) determining a second acceleration associated with the second rotor blade based on the first measured acceleration taking into account an angular offset between the first and a second rotor blade;
b) determining a second reference bending moment and/or a second reference axial force based on the second acceleration;
c) determining a second measured bending moment and/or a second measured axial force based on measured values from the at least one strain sensor of the second blade load measurement system and a second adjustment parameter set with second initial adjustment parameters associated with the second blade load measurement system;
d) determining a second deviation of the second reference bending moment and/or the second reference axial force from the second measured bending moment and/or the second measured axial force;
e) adapting the adjustment parameter values of the second adjustment parameter set for the second blade load measurement system such that the second deviation is less than or equal to a threshold value. The second acceleration is associated with the second rotor blade and is determined from the first measured acceleration, taking into account an angular offset between the first and a second rotor blade. In other words, the second acceleration represents a transformation of the first measured acceleration from the first rotor blade to the second rotor blade depending on the angle between the rotor blades. The second reference bending moment and/or the second reference axial force may be determined from the second acceleration. The second reference bending moment and/or the second reference axial force generally relate to the blade flange but may also relate to any other position on the second rotor blade.

On the second rotor blade, at least one second blade load measuring system having at least one strain sensor is arranged, which determines the second measured bending moment and/or the second measured axial force. The same conditions apply to the type and positioning of the second strain sensor as to the at least one strain sensor of the first blade load measuring system on the first rotor blade.

The second deviation may be determined by comparing the second reference bending moment and/or the second reference axial force to the second measured bending moment and/or the second measured axial force.

Based on the second deviation, the adjustment parameter values of the second adjustment parameter set are adapted such that the second deviation is less than or equal to the threshold value. In particular, the threshold value for the second deviation may correspond to the threshold value for the first deviation.

By simply measuring a first acceleration with a first acceleration sensor, the blade load measurement system on the second rotor blade may also be easily adjusted using the angular offset between the rotor blades based on the number of rotor blades.

The second adjustment parameter set of the second blade load measurement system may comprise one or more suitable parameters for adjusting the second blade load measurement system or strain sensor. The initial adjustment parameter values of the second adjustment parameter set may be any specified parameter values. The calculation time may be shortened if suitable adjustment parameter values are specified as initial adjustment parameter values. For example, in particular initial, adjustment parameter values of an adjustment parameter set of a structurally and functionally similar wind turbine may be used. Optionally, in particular initial, adjustment parameter values can be used, which are determined from a stiffness of the second rotor blade and/or a position of the second strain sensor and/or a wavelength of the second strain sensor.

In an advantageous embodiment, steps a) to d) may be performed repeatedly, in particular for at least 50, more particularly at least 100, more particularly at least 1000, more particularly at least 10000 repetitions, and instead of step e) the adjustment parameter values may be adapted such that the first or second deviations detected in step d) are less than or equal to a threshold value, with different pitch angles and/or different accelerations being detected at each repetition.

For example, steps a) to d) may be performed a predetermined number of times or for a predetermined period of time. Both the period of time and the number of repetitions of steps a) to d) are basically unlimited. For the purpose of increasing the accuracy of the adjustment, the period of time and/or the number of repetitions of steps a) to d) may be specified at a minimum value. Similarly, for the purpose of reducing time and costs, the period of time and/or the number of repetitions of steps a) to d) may be limited to a maximum value. Similarly, the period of time and/or the number of repetitions of steps a) to d) may be interrupted and continued at another time. This has the advantage that the adjustment process may be interrupted if the wind turbine cannot be operated safely for adjustment purposes due to external environmental influences. The entire period of time may, for example, be at least two minutes, preferably at least ten minutes, more preferably at least 15 minutes and/or no more than one hour, preferably no more than 45 minutes, more preferably no more than 30 minutes. The period of time or the number of repetitions of steps a) to d) may be determined in particular depending on how often a first measured acceleration is rejected. The first and second deviations determined in step d) may, for example, be combined to form a common first and common second deviation, respectively, for example in the form of a vector or a matrix comprising the first and/or second deviations. By first performing steps a) to d) repeatedly, an amount of data, in particular first and/or second deviations, may be collected, on the basis of which a first adjustment parameter set is determined and selected. In this way, an adjustment may be made at a later time, depending on the predetermined period of time or the predetermined number of executions.

In an advantageous embodiment, prior to step a), a pitch angle may be used and/or a defined pitch angle, in particular different pitch angles, may be set. For example, pitch angle signals may be used which are detected by the wind turbine by default. A wind turbine is usually operated at different pitch angles. By setting a defined pitch angle, in particular by setting different pitch angles, the first rotor blade can be brought into an aerodynamic position which is good in terms of energy and safety at any time, so that the rotor of the wind turbine always operates safely at the optimal operating point. Additionally, by determining the pitch angle, a critical operating state of the wind turbine may be identified. By setting a defined pitch angle, damage to the wind turbine can be avoided during calibration of the first blade load sensor.

In an advantageous embodiment, the first acceleration measured by the first acceleration sensor may be rejected if a wind speed exceeds a wind speed threshold value. The wind speed prevailing in the surroundings of the wind turbine may be measured using sensors for detecting wind speeds, which may be arranged on or near the wind turbine. The measured wind speed may be compared to a specified wind speed threshold value for a maximum wind speed. If the measured current wind speed is less than the wind speed threshold value for the maximum wind speed, the first measured acceleration may be used for further adjustment of the blade load measurement system. If the wind speed is equal to or greater than the wind speed threshold value for the maximum wind speed, the first measured acceleration may be rejected. In this way, it can be ensured that the first reference bending moment is not excessively influenced by wind forces that occur and distorted thereby. The wind speed threshold value for the maximum wind speed may be, for example, 10 m/s, preferably 8 m/s, more preferably 5 m/s, more preferably 3 m/s.

In a preferred embodiment, the first acceleration sensor may measure accelerations in at least one, in particular two, more particularly three spatial directions and/or may be formed by an inertial measurement unit and/or an acceleration sensor, preferably two, more preferably three acceleration sensors, may be arranged in the hub of the wind turbine.

The first acceleration sensor may detect positive and negative translational accelerations along one, in particular two, more particularly all three spatial directions, i.e., in x-, y- and z-directions. Thus, the first measured acceleration may include an acceleration in at least one, in particular two, more particularly three directions from the x-direction, y-direction and z-direction. By using more than one first acceleration sensor, the measurement system may be designed to be functionally redundant so that if one acceleration sensor fails, the other acceleration sensors can take over the measuring function. For this purpose, the acceleration sensors are configured to be functionally and structurally identical. Moreover, the accuracy of the measurement may be increased by comparing the measured values of the individual acceleration sensors to one another to identify differences and thus possible measurement errors and to obtain a correct measured value.

In particular, the first acceleration sensor may be arranged in the hub of the rotor. In particular, the first acceleration sensor may be oriented such that it can measure an acceleration in the direction of a blade axis of the first rotor blade. The first acceleration sensor may also measure two further accelerations orthogonal to the first measured acceleration.

In each rotor blade position, different forces and moments may act on the rotor blade, which are to be detected correctly by the blade load measurement system. Therefore, it may be necessary to determine the acceleration uniquely associated with a rotor blade position using the first acceleration sensor. The first measured acceleration may be associated with a first rotor blade position of the first rotor blade. The second measured acceleration may be associated with a second rotor blade position of the second rotor blade, wherein the second rotor blade may be arranged around the hub at an angular offset to the first rotor blade. A plurality of rotor blade positions may be associated with a measured acceleration. For example, an acceleration associated with a rotor blade position may be indicated using an acceleration vector, the vector comprising accelerations in three orthogonal spatial directions. Based on the measured acceleration, bending moments and axial forces may be determined directly using the known location of the centre of gravity and mass of the blade.

If the first acceleration sensor is arranged offset from the blade axis by a mounting offset, for example a translational or rotational displacement, in particular an angular offset, the acceleration sensor measures different accelerations. The exact positioning and orientation of the acceleration sensor on the blade axis may ensure that the first measured acceleration and thus the first reference bending moment and/or the first reference axial force are not distorted due to a mounting offset. In practice, however, this may not always be feasible, and an actual installation direction of the sensors may deviate from the optimum installation direction described. It may therefore be necessary to identify this mounting offset and take it into account when adjusting the blade load measurement system in order to increase the accuracy of the adjustment.

The strain sensor may be any suitable sensor, such as a piezoelectric strain gauge, a fibre Bragg grating graph, to detect strains with or without temperature compensation. Depending on the application, it may be necessary for the strain sensor to be arranged at a certain position on the first or second rotor blade. Therefore, the strain sensor can basically be located at any position on or in the first or second rotor blade.

In an advantageous embodiment, the at least one strain sensor of the first or second blade load measurement system may be arranged on the first or second rotor blade in a radial range of no more than 50%, preferably no more than 30%, of the length of the rotor blade starting from the blade flange. This allows determination of the first or second measured bending moment and/or the first or second measured axial force and thus to further increase the accuracy of adjustment. In an advantageous embodiment, the adjustment of the first and/or second blade load measurement system on the first and/or second rotor blade may be carried out by a computing device on site at the wind turbine and/or by a remote computing device. Depending on the application, an adjustment by a computing device on site at the wind turbine or from a remote computing device may be reasonable. For example, a computing device on site at the wind turbine may be suitable in offshore wind turbines to carry out the adjustment of the blade load measurement system on site. A remote computing device may be desired, for example, to make corrections to the adjustment process or to monitor the adjustment process. If the adjustment is carried out by a remote computing device, in particular a unit for storing measurement data and for wireless or wired transport of the measurement data to the remote computing unit is advantageous. The computing device may be part of the blade load measurement system. The computing device may consist of one or more computing units. Further, the adjustment of the first or second blade load measurement system may be carried out by a common, i.e., the same, computing device or by different computing devices.

In particular, the object mentioned at the beginning is further achieved by a device for adjusting a first blade load measurement system having at least one strain sensor in a first rotor blade of a wind turbine, having:
a unit for measuring an acceleration, configured to measure a first acceleration with a first acceleration sensor;
a unit for determining a bending moment and/or an axial force, configured to determine a first reference bending moment and/or a first reference axial force based on the first measured acceleration and a first measured bending moment and/or a first measured axial force based on measured values from the at least one strain sensor of the first blade load measurement system and a first adjustment parameter set with first initial adjustment parameter values associated with the first blade load measurement system;
a unit for determining a deviation of bending moments and axial forces, configured to determine a first deviation of the first reference bending moment and/or the first reference axial force from the first measured bending moment and/or the first measured axial force;
a unit for adapting adjustment parameter values of an adjustment parameter set for a blade load measurement system, configured to adapt adjustment parameter values of the first adjustment parameter set for the first blade load measurement system such that the first deviation is less than or equal to a threshold value.

In particular, the device described herein may be used using the method described herein for adjusting a first blade load measurement system having at least one strain sensor, or the method may be implemented by the device described. In this respect, the modifications and developments described with regard to the method may also be used with regard to the device.

In an advantageous embodiment, the device may be suitable for adjusting a second blade load measurement system having at least one strain sensor on a second rotor blade of a wind turbine, wherein
the unit for measuring an acceleration is configured to determine a second acceleration based on the first measured acceleration and taking into account an angular offset between the first and second rotor blades;
wherein the unit for determining a bending moment and/or an axial force is configured to determine a second reference bending moment and/or a second reference axial force based on the second acceleration and a second measured bending moment and/or a second measured axial force based on measured values from the at least one strain sensor of the second blade load measurement system and a second adjustment parameter set with second initial adjustment parameter values associated with the second blade load measurement system;
wherein the unit for determining a deviation of bending moments and axial forces is configured to determine a second deviation of the second reference bending moment and/or the second reference axial force from the second measured bending moment and/or the second measured axial force;
wherein the unit for adapting adjustment parameter values of an adjustment parameter set for a blade load measurement system is configured to adapt adjustment parameter values of the second adjustment parameter set for the second blade load measurement system such that the second deviation is less than or equal to a threshold value.

In an advantageous embodiment, the device may further comprise a pitch angle application and/or setting unit to apply a pitch angle and/or to set a defined pitch angle, in particular different pitch angles.

In an advantageous embodiment, the device may further comprise a unit for rejecting an acceleration, configured to compare a wind speed to a wind speed threshold value and to select the first measured acceleration if the wind speed is less than a wind speed threshold value and to reject the first measured acceleration if the wind speed is greater than a wind speed threshold value.

The object is further achieved in particular by a wind turbine which has a rotor with a hub and a rotor blade, extending radially from the hub, wherein the number of rotor blades comprises at least a first rotor blade, and the wind turbine is provided with a device as described above.

There are similar or identical advantages to those already described in connection with the method described above.

The object is further achieved in particular by a computer-readable storage medium, containing instructions which cause at least one processor to implement a method as described above when the instructions are executed by the at least one processor.

There are similar or identical advantages to those already described in connection with the method described above.

Further embodiments will become apparent from the dependent claims.

### BRIEF DESCRIPTION OF THE DRAWINGS

In the following, the invention will be explained in greater detail with reference to exemplary embodiments. In the drawings:

FIG. 1: shows a schematic side view of a wind turbine with rotor blades according to an embodiment described herein;

FIG. 2: shows a schematic side view of a rotor blade according to an embodiment described herein;

FIG. 3: shows a flowchart of a method for adjusting a first blade load measurement system having at least one strain sensor on a first rotor blade according to an embodiment described herein.

FIG. 4: shows a flowchart of a method for adjusting a second blade load measurement system having at least one strain sensor on a second rotor blade according to an embodiment described herein.

### DESCRIPTION OF EMBODIMENT(S)

Exemplary embodiments of the invention are explained below. In the drawings, like reference numerals designate the same or similar features of the respective embodiments.

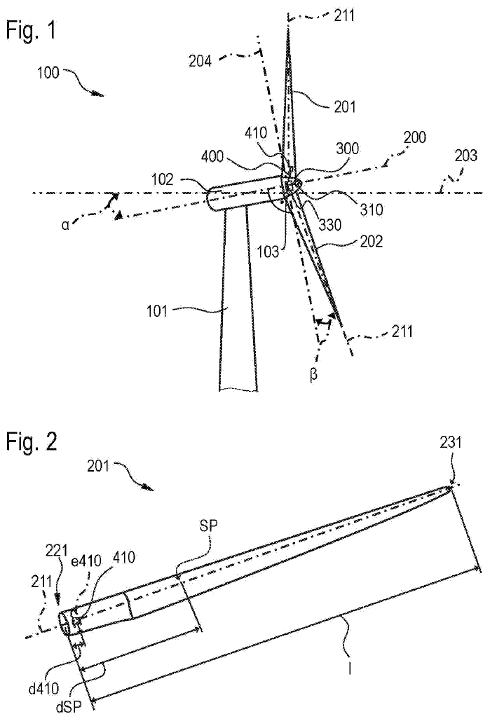

FIG. 1 shows a schematic side view of a wind turbine 100 with a first 201, second 202 and third (not shown here) rotor blade according to embodiments described herein. Wind turbine 100 includes a tower 101 and a nacelle 102. A rotor is fixed to nacelle 102. The rotor includes a hub 103 to which rotor blades 201, 202 are fixed. According to typical embodiments, the rotor has at least one, preferably two rotor blades, more preferably three rotor blades. When the wind turbine is in operation, the rotor, i.e., hub 103 with the rotor blades mounted thereto, rotates about an axis 200 which corresponds to a central axis of nacelle 102 through a hub centre. As such, nacelle 102 or its central axis 200 is inclined by a tilt angle a of eight degrees relative to a horizontal orientation thereof with respect to a flat, horizontal earth surface, i.e., a horizontal central axis 203. An axis 211 runs along a longitudinal extension of each rotor blade 201, 202. Rotor blades 201, 202 or their respective axes 211 are tilted away from the tower with respect to an axis 204 in a plane of rotation of the rotor or perpendicular to central axis 200 by a cone angle β of four degrees. A generator is driven to generate electricity.

As shown in FIG. 1, at least a first acceleration sensor 310 is provided in hub 103. First acceleration sensor 310 is connected via a signal line 300 to an analysis unit 330, which analyses the measured signals. According to some embodiments, which may be combined with other embodiments, first acceleration sensor 310 is a 6-DOF acceleration sensor measuring accelerations and angular accelerations in three spatial directions, i.e., six degrees of freedom.

Further, in FIG. 1, a first blade load measurement system 410, comprising four strain sensors, is arranged near the blade flange on first rotor blade 201. Each strain sensor is configured as a fibre-optic sensor. For fibre-optic strain sensors, an optical signal is transmitted to analysis unit 330 by means of an optical waveguide 400, for example an optical fibre.

FIG. 2 shows a schematic side view of first rotor blade 201 according to embodiments described herein. Length l of rotor blade 201 extends from a blade flange 221 to a blade tip 231. FIG. 2 illustrates also centre of gravity SP and its distance dsp from the blade flange of the rotor blade. Furthermore, FIG. 2 shows the positioning of first blade load measurement system 410 on the first rotor blade at a distance d₄₁₀ of 2% of the length of the rotor blade starting from blade flange 221. The first blade load measurement system comprises four strain sensors arranged symmetrically within a first plane e₄₁₀ of a rotor blade cross section, so that only bending moments are required for adjustment.

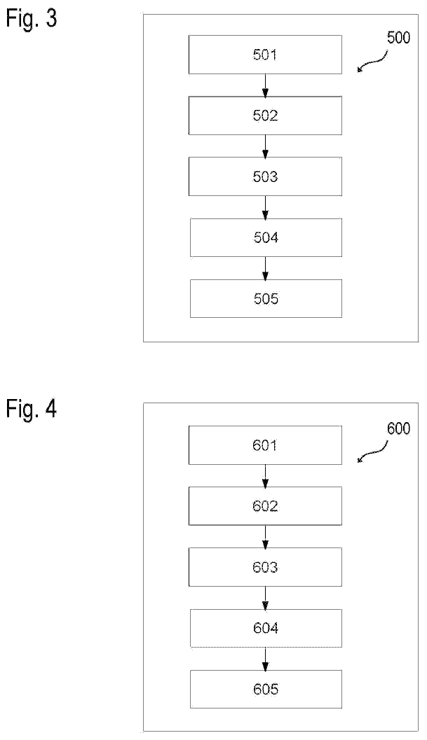

FIG. 3 shows a flowchart of a method 500 for adjusting first blade load measurement system 410 or the strain sensors thereof according to the embodiment described herein. When the rotor and thus first rotor blade 201 rotates around axis of rotation 200, first acceleration sensor 310 and the strain sensors of first blade load measurement system 410 also experience a corresponding rotational movement. Depending on the position of first rotor blade 201, different accelerations, forces and moments act on the first rotor blade. For example, first rotor blade 201 is in a first position S1 if blade axis 211 thereof is oriented horizontally, i.e., orthogonally to a longitudinal axis of tower 101.

In a first step 501, first acceleration sensor 310 measures a first acceleration in this first position S1. First acceleration sensor 310 is arranged in the rotating hub and is oriented such that it can measure accelerations along blade axis 211; optionally, it may measure accelerations in any three spatial directions which are orthogonal to one another to enable calculation of the acceleration in blade axis direction 211 therefrom; hereinafter, this is referred to as the first measured acceleration in the z-direction of the first rotor blade. First acceleration sensor 310 may further measure two further accelerations orthogonal to the first measured acceleration in the z-direction or enable calculation thereof from the acceleration measurements from several spatial directions; hereinafter, these are referred to as the first measured acceleration in the y-direction and as the first measured acceleration in the x-direction of the first rotor blade.

The earth's gravitational acceleration at the rotor blade is vectorially divided depending on the cone angle, the tilt angle, the pitch angle and the rotor blade position around axis of rotation 200. In first position S1, the earth's gravitational acceleration in the z-direction along blade axis 211 is equal to zero and the earth's gravitational acceleration of 9.81 m/s² is only divided into an acceleration in the y-direction and an acceleration in the x-direction.

It is known from the production of the first, second and third rotor blades that the mass M of a rotor blade is 20,000 kg and the centre of gravity SP lies along blade axis 211 of the rotor blade at a distance d_{SP} of 20 m from blade flange 221.

In a second step 502, a first reference bending moment M_{B-1-acceleration sensor} of first rotor blade 201 is determined with respect to blade flange 221 as a load reference cross section based on the first measured acceleration. The first reference bending moment of first rotor blade M_{B-1-acceleration sensor} is 3924 kNm.

Similarly, the rotor blade experiences a force and torque effect in the first plane of the rotor blade cross section in this first position S1, which is detected by the strain sensors of first blade load measurement system 410. In a third step 503, based on the measurements from the strain sensors and a first adjustment parameter set with first initial adjustment parameter values associated with the first blade load measurement system, a first measured bending moment M_{B-1-strain} sensor of first rotor blade 201 is determined with respect to blade flange 221 as a load reference section. In the present case, a first measured bending moment M_{B-1-strain} sensor for the first rotor blade of 3610 kNm is determined.

In a next step 504, the first reference bending moment M_{B-1-acceleration} sensor IS compared to the first measured bending moment M_{B-1-strain} sensor to determine a first deviation A1. The first deviation A1 is 8% in the embodiment described.

In a next step 505, based on first deviation A1, the adjustment parameter values of first adjustment parameter set KP1 for the first blade load measuring system are adapted such that first deviation A1 is less than or equal to a threshold value. In the embodiment described, threshold value S is 1%. With a measured bending moment of M_{B-1-strain} sensor of 3904 kNm, first deviation A1 is 0.5% and is therefore less than threshold value S, so that the adjustment parameter values of adjustment parameter set KP1 are selected for adjusting the first blade load measurement system or its strain sensors.

FIG. 4 shows a flowchart of a method 600 for adjusting a second blade load measurement system 420 according to embodiments described herein. The wind turbine has a second rotor blade 202, which is arranged on the hub at an angular offset W of 180° to first rotor blade 201. In a first step 601, a second acceleration associated with the second rotor blade is determined based on first measured acceleration 311 and angular offset W between the first and second rotor blades. The first measured acceleration in the x-, y- and z-directions is therefore converted into a second acceleration in the x-, y- and z-directions.

In a second step 602, a second reference bending moment M_{B-2-acceleration} sensor Of second rotor blade 202 is determined from the second acceleration. The second reference bending moment M_{B-2-acceleration} sensor on the second rotor blade is 3924 kNm. The strain sensors of second blade load measurement system 420, like the strain sensors of first blade load measurement system 410, are located near the blade flange.

In a third step, based on the measurements of the strain sensors of second blade load measurement system 420 of the second rotor blade and a second adjustment parameter set with second initial adjustment parameter values associated with second blade load measuring system 420, a second measured bending moment M_{B-2-strain} sensor of second rotor blade 202 is determined with reference to the load reference section, i.e., blade flange 221 of second rotor blade 202. In the present case, the second blade load measurement system determines a second measured bending moment M_{B-2-strain sensor} of the second rotor blade of −3010 kNm.

In a next step 604, the second reference bending moment of the second rotor blade M_{B-2-acceleration} sensor is compared to the second measured bending moment of the second rotor blade M_{B-2-strain} sensor and a second deviation A2 is determined, which is 23% in the embodiment described.

In a next step 605, based on second deviation A2, the adjustment parameter values of second adjustment parameter set KP2 for second blade load measurement system 420 are adapted such that second deviation A2 is less than or equal to the threshold value of 1%. With a second measured bending moment of the second rotor blade of M_{B-2-strain sensor} of −3889 kNm, second deviation A2 is 0.9% and is therefore less than threshold value S, which is why the adjustment parameter values of second adjustment parameter set KP2 for adjusting the second blade load measurement system or the strain sensors thereof are selected at the second rotor blade.

### LIST OF REFERENCE NUMERALS

100 Wind turbine
101 Tower
102 Nacelle
103 Hub
200 Axis of rotation of the rotor
201/202 First/second rotor blades
203 Horizontal central axis of the nacelle
204 Axis in the plane of rotation of the rotor
W Angle between the rotor blades around the axis of rotation
211 Blade axis
221 Blade flange
231 Blade tip
l Length of the rotor blade from the blade flange to the blade tip
M Mass of the rotor blade
SP Centre of gravity of the rotor blade
d_{SP} Distance of the centre of gravity from the blade flange of the rotor blade
e₄₁₀ First plane of the rotor blade cross section of the first rotor blade
d₄₁₀ Distance of first blade load measurement system 410 at the first rotor blade from the blade flange
S1 First position of the first rotor blade
300 Signal line
310 First acceleration sensor
330 Analysis unit
400 Optical waveguide
410 First blade load measurement system with four strain sensors of the first rotor blade
420 Second blade load measurement system with four strain sensors of the second rotor blade
M_{B-1-acceleration sensor} First reference bending moment due to accelerations at the first rotor blade
M_{B-2-acceleration sensor} Second reference bending moment due to accelerations at the second rotor blade
M_{B-1-strain sensor} First bending moment based on measured values from the at least one strain sensor of the first blade load measurement system and a first adjustment parameter set with first initial adjustment parameter values associated with the first blade load measurement system
M_{B-2-strain sensor} Second bending moment based on measured values from the at least one strain sensor of the second blade load measurement system and a second adjustment parameter set associated with the second blade load measurement system with second initial adjustment parameter values
A1/A2 First/second deviation
S Threshold value
KP1/KP2 First/second adjustment parameter set for the first/second blade load measurement system of the first/second rotor blade
500 Method for adjusting a first blade load measurement system having at least one strain sensor
501 Measuring of a first acceleration with a first acceleration sensor
502 Determining a first reference bending moment based on the first measured acceleration of the first rotor blade
503 Determining a first measured bending moment based on measured values from the at least one strain sensor of the first blade load measurement system and a first adjustment parameter set with first initial adjustment parameter values associated with the first blade load measurement system
504 Determining a first deviation of the first reference bending moment from the first measured bending moment
505 Adapting the adjustment parameter values of the first adjustment parameter set for the first blade load measurement system such that the first deviation is less than or equal to a threshold value
600 Method for adjusting a second blade load measurement system having at least one strain sensor
601 Determining a second acceleration associated with the second rotor blade based on the first measured acceleration and an angular offset between the first and a second rotor blade
602 Determining a second reference bending moment based on the second acceleration of the second rotor blade
603 Determining a second measured bending moment based on measured values from the at least one strain sensor of the second blade load measurement system and a second adjustment parameter set with second initial adjustment parameters associated with the second blade load measurement system
604 Determining a second deviation of the second reference bending moment from the second measured bending moment
605 Adapting the adjustment parameter values of the second adjustment parameter set for the second blade load measurement system such that the second deviation is less than or equal to a threshold value

1. A computer-implemented method for adjusting a blade load measurement system comprising a strain sensor on a rotor blade of a wind turbine, the computer-implemented method comprising:
measuring an acceleration of the rotor blade with an acceleration sensor;
determining a reference bending moment of the rotor blade and/or a reference axial force based on the acceleration;
determining a measured bending moment and/or a measured axial force based on measured values from a strain sensor of the rotor blade and of a blade load measurement system and an adjustment parameter set with initial adjustment parameter values associated with the blade load measurement system;
determining a deviation of the reference bending moment and/or the reference axial force from the measured bending moment and/or the measured axial force, respectively; and
adapting the initial adjustment parameter values of the adjustment parameter set for the blade load measurement system such that the deviation is less than or equal to a threshold value.

2. The computer-implemented method according to claim 1, wherein the method comprises adjusting a second blade load measurement system comprising a second strain sensor on a second rotor blade, wherein the adjusting the second blade load measurement system comprises:
determining a second acceleration associated with the second rotor blade based on the measured acceleration taking into account an angular offset between the rotor blade and the second rotor blade;
determining a second reference bending moment of the second rotor blade and/or a second reference axial force of the second rotor blade based on the second acceleration;
determining a second measured bending moment of the second rotor and/or a second measured axial force of the second rotor based on measured values from the second strain sensor of the second blade load measurement system and a second adjustment parameter set with second initial adjustment parameters associated with the second blade load measurement system;
determining a second deviation of the second reference bending moment and/or the second reference axial force from the second measured bending moment and/or the second measured axial force, respectively; and
adapting the second initial adjustment parameter values of the second adjustment parameter set for the second blade load measurement system such that the second deviation is less than or equal to a second threshold value.

3. The computer-implemented method according to claim 1, wherein the measuring, the determining a reference bending moment and or a reference axial force, the determining a measured bending moment and/or a measured axial force, and the determining a deviation are performed repeatedly for at least 50 repetitions, and instead of performing the adapting, the adjustment parameter values are adapted such that the deviation determined is less than or equal to a second threshold value, with different accelerations being detected at each repetition.

4. The computer-implemented method according to claim 1, wherein prior to the measuring the acceleration, a pitch angle is applied and/or a defined pitch angle is set.

5. The computer-implemented method according to claim 1, wherein acceleration is rejected if a wind speed exceeds a wind speed threshold value.

6. The computer-implemented method according to claim 1, wherein the acceleration sensor measures accelerations in at least one direction.

7. The computer-implemented method according to claim 1, wherein the strain sensor of the blade load measurement system is arranged on the rotor blade in a radial range of no more than 50% of a length of the rotor blade starting from a blade flange of the rotor blade.

8. The computer-implemented method according to claim 1, wherein the method is carried out by a computing device on site at a wind turbine that comprises the rotor blade and/or by a remote computing device.

9. A device for adjusting a blade load measurement system comprising a strain sensor on a rotor blade of a wind turbine, the device comprising:
a first unit for measuring an acceleration of a rotor blade of a wind turbine with an acceleration sensor;
a second unit for determining a bending moment of the rotor blade and/or an axial force of the rotor blade and for determining reference bending moment of the rotor blade and/or a reference axial force of the rotor blade based on the acceleration and for determining a measured bending moment of the rotor blade and/or a measured axial force of the rotor blade based on measured values from a strain sensor of the rotor blade of a blade load measurement system and an adjustment parameter set with initial adjustment parameter values associated with the blade load measurement system;
a third unit for determining a deviation of bending moments of the rotor blade and axial forces of the rotor blade, the third unit configured to determine a deviation of the reference bending moment and/or the reference axial force from the measured bending moment and/or the measured axial force, respectively; and
a fourth unit for adapting adjustment parameter values of an adjustment parameter set for a blade load measurement system, the fourth unit configured to adapt adjustment parameter values of the adjustment parameter set for the blade load measurement system such that the deviation is less than or equal to a threshold value.

10. The device according to claim 9, wherein the device adjusts a second blade load measurement system comprising a second strain sensor on a second rotor blade of the wind turbine,
wherein the first unit for measuring an acceleration is configured to determine a second acceleration of the second rotor blade based on the acceleration and taking into account an angular offset between the rotor blade and the second rotor blade;
wherein the second unit for determining a bending moment and/or an axial force is configured to determine a second reference bending moment of the second rotor blade and/or a second reference axial force of the second rotor blade based on the second acceleration and a second measured bending moment of the second rotor blade and/or a second measured axial force of the second rotor blade based on measured values from the second strain sensor of the second blade load measurement system and a second adjustment parameter set with second initial adjustment parameter values associated with the second blade load measurement system;
wherein the third unit for determining a deviation of bending moments and axial forces is configured to determine a second deviation of the second reference bending moment of the second rotor blade and/or the second reference axial force of the second rotor blade from the second measured bending moment of the second rotor blade and/or the second measured axial force of the second rotor blade, respectively; and
wherein the fourth unit for adapting adjustment parameter values of an adjustment parameter set for a blade load measurement system is configured to adapt adjustment parameter values of the second adjustment parameter set for the second blade load measurement system such that the second deviation is less than or equal to a second threshold value.

11. The device according to claim 9, further comprising a pitch angle application unit and/or a setting unit to apply a pitch angle and/or to set a defined pitch angle, respectively.

12. The device according to claim 9, further comprising a fifth unit for rejecting an acceleration, the fifth unit configured to compare a wind speed to a wind speed threshold value and to select the acceleration if the wind speed is less than the wind speed threshold value, and to reject the acceleration if the wind speed is greater than the wind speed threshold value.

13. A wind turbine comprising:
a rotor with a hub;
a rotor blade attached to the hub and extending radially from the hub; and
a device for adjusting a blade load measurement system comprising:
a first unit for measuring an acceleration of the rotor blade of the wind turbine with an acceleration sensor;
a second unit for determining a bending moment of the rotor blade and/or an axial force of the rotor blade and for determining a reference bending moment of the rotor blade and/or a reference axial force of the rotor blade based on the acceleration and for determining a measured bending moment of the rotor blade and/or a measured axial force of the rotor blade based on measured values from a strain sensor of the rotor blade of a blade load measurement system and an adjustment parameter set with initial adjustment parameter values associated with the blade load measurement system;
a third unit for determining a deviation of bending moments of the rotor blade and axial forces of the rotor blade, the third unit configured to determine a deviation of the reference bending moment and/or the reference axial force from the measured bending moment and/or the measured axial force, respectively; and
a fourth unit for adapting adjustment parameter values of an adjustment parameter set for a blade load measurement system, the fourth unit configured to adapt adjustment parameter values of the adjustment parameter set for the blade load measurement system such that the deviation is less than or equal to a threshold value.

14. A computer-readable storage medium, containing instructions which cause at least one processor to implement a method when the instructions are executed by the at least one processor, wherein the method comprises:
measuring an acceleration of a rotor blade with an acceleration sensor;
determining a reference bending moment of the rotor blade and/or a reference axial force based on the acceleration;
determining a measured bending moment and/or a measured axial force based on measured values from a strain sensor of the rotor blade and of a blade load measurement system and an adjustment parameter set with initial adjustment parameter values associated with the blade load measurement system;
determining a deviation of the reference bending moment and/or the reference axial force from the measured bending moment and/or the measured axial force, respectively; and
adapting the initial adjustment parameter values of the adjustment parameter set for the blade load measurement system such that the deviation is less than or equal to a threshold value.

15. The computer-implemented method according to claim 1, wherein the acceleration sensor is arranged in a hub of a wind turbine to which the rotor blade is attached.
